(19) United States
(12) Patent Application Publication
(10) Pub. No.: US 2014/0227669 A1
(43) Pub. Date: Aug. 14, 2014

(54) Guided Tool Tips for Expression Calculation

(71) Applicant: Texas Instruments Incorporated, Dallas, TX (US)

(72) Inventors: Sajjad Mahmood Khan, Allen, TX (US); Joe Dean Hill, Wylie, TX (US); Michel Georges Stella, Dallas, TX (US); Mathieu Ippersiel, Ternay (FR); Christopher Robin Roberts, Richardson, TX (US)

(73) Assignee: Texas Instruments Incorporated, Dallas, TX (US)

(21) Appl. No.: 14/165,885

(22) Filed: Jan. 28, 2014

Related U.S. Application Data
(60) Provisional application No. 61/763,072, filed on Feb. 11, 2013.
(60) Provisional application No. 61/769,477, filed on Feb. 26, 2013.

(51) Int. Cl. G09B 23/02

(52) U.S. Cl. CPC G09B 23/02
USPC 434/201

(57) ABSTRACT

A graphical object is displayed on a display screen of a student device. The student device may then display one or more data elements pertaining to the graphical object on a display screen of the student device. An expression entered by the student may then be displayed on the display screen of the student device. Variables in the expression may be determined by parsing the expression. A sequence of prompts is presented by the student device to associate each of the variables of the expression with one of the data elements. In response to each prompt, a data element is selected and associated with a variable in response to user input to the student device.

### CLAIM OF PRIORITY UNDER 35 U.S.C. 119 (e)

The present application claims priority to and incorporates by reference U.S. Provisional Application No. 61/763,072, (attorney docket TI-73457PS) filed Feb. 11, 2013, entitled “GUIDED TOOL TIPS FOR EXPRESSION CALCULATION”. The present application also claims priority to and incorporates by reference U.S. Provisional Application No. 61/769,477, (attorney docket TI-73457PS1) filed Feb. 26, 2013, entitled “GUIDED TOOL TIPS FOR EXPRESSION CALCULATION”.

### BACKGROUND OF THE INVENTION

1. Field of the Invention

Embodiments of the present invention generally relate to guiding a user of a student device to perform expression calculation using the student device.

2. Description of the Related Art

With ever increasing frequency, school classrooms are equipped with a classroom learning system in which digital devices, e.g., handheld calculators, for student use are connected via a network to a host computer used by the teacher. Such a classroom learning system allows a teacher to perform actions such as creating and managing lessons, transferring files between the computer and the digital devices, monitoring student activity on the digital devices using screen captures, polling, assessments, etc., and performing various interactive activities with the students. Various tools are also provided for creating, distributing, and analyzing educational content. The TI-Nspire™ Navigator™ System from Texas Instruments, Inc. is an example of such a classroom learning system.

In addition to calculator based networks, schools are now embarking on BYOD (Bring Your Own Device) initiatives. In various schools, students are using various computing devices other than calculators that they own, such as: tablets, iPads, laptops, smart phones, etc, for example.

The TI-Nspire system provides tools to perform calculations, graphing, and complex problem solving by a student on a handheld calculator or other computer system. Other math/graphing based software packages, such Geogebra, MathStudio, PocketCAS may also be used on student devices.

### SUMMARY

Embodiments of the present invention relate to methods and systems to provide guided tool tips to aid a student in performing expression calculation on a student computing device.

### BRIEF DESCRIPTION OF THE DRAWINGS

Particular embodiments in accordance with the invention will now be described, by way of example, and with reference to the accompanying drawings:

FIG. 1 shows an example of a classroom network;

FIGS. 2-3 illustrate an example student device that is equipped with a network interface for use in the classroom of FIG. 1;

FIGS. 4A-4B illustrate the parts of an equation;

FIGS. 5-12 illustrate an example of using a guide tool to evaluate an expression;

FIG. 13 illustrate another example of using the guide tool to evaluate an expression; and

FIG. 14 is a flow diagram of a method for using a guide tool to evaluate expressions.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skills in the art that the invention may be practiced without these specific details. In other instances, well-known features have not been described in detail to avoid unnecessarily complicating the description.

Embodiments of the present invention are discussed below with respect to an embodiment on a tablet computer that contains software applications that provide functionality that is similar to a hand held graphing calculator. It should be noted, however, that embodiments of the present invention may be useful for other types of electronic devices, e.g., laptop computers, desktop computers, handheld computing devices. Examples of other types of handheld computing devices in which embodiments of the present invention may be useful include scientific calculators, advanced calculators able to upload and run software applications, handheld-sized limited-purpose computer devices, handheld-sized educational computer devices, handheld-sized portable computer devices, portable computer devices, personal digital assistants (PDAs), palmtop computers, cellular or mobile telephones, and any combination thereof.

Some prior 2D and 3D graphing software products include the ability to calculate a mathematical expression related to geometrical measurements. However, these prior products may lack key features to make the calculation easy to perform. Embodiments of the invention provide a guide tool that provides a guiding mechanism for the user to follow to perform a calculation; this may be in the form of pop-up labels and hints, for example. In some embodiments, highlighting of the values used in the calculation of the expression provides additional guidance. The guide tool may help a user better understand a calculation problem when trying to perform multiple calculations on the screen, where calculations may potentially depend upon each other.

The guide tool approach described herein provides a streamlined user experience to performing a calculation of an expression while in a 2D or 3D graphing application. The approach uses any user-entered expression and any numerical data item values on the screen. The values can be numbers, variables with a numerical value assigned to them, or even values on the x-, y-, and z-axes. When the user initiates the calculation of the expression, the user is guided through the calculation process by both descriptive prompts and visual highlighting of the values currently associated with the expression. This may provide a streamlined experience to users when using any number on a graph in 2D/3D mode or geometry page for a calculation by automatically highlighting variables that become part of the calculation. In some embodiments, the names of the variables may be provided next to the values to provide visual feedback when highlighted.

Handheld calculators have progressed to be very sophisticated processing systems. A handheld calculator, such as the TI-Nspire™ from Texas Instruments, is capable of operating on one or more documents. In one version of such a calculator, each document may be divided into multiple problems. Each problem may contain many pages. Each page may be divided into several work areas. Each work area may contain any of the TI-Nspire™ applications: Calculator, Graph, Geometry, Lists & Spreadsheet, Data & Statistics and Notes, for example.

Students are beginning to use many different BYODs (Bring Your Own Device), such as: calculators, tablets, iPads, laptops, smart phones, etc, for example. Many school campuses have now been upgraded to provide a network infrastructure that allows students to connect their device(s) and thereby interact with teachers and other students as well as access resources on the World Wide Web.

Embodiments of the invention may be used in a stand-alone manner by a student or other user, such as at home or other places away from school. Many schools now provide networked environments that allow teacher and student collaboration to enhance the learning experience.

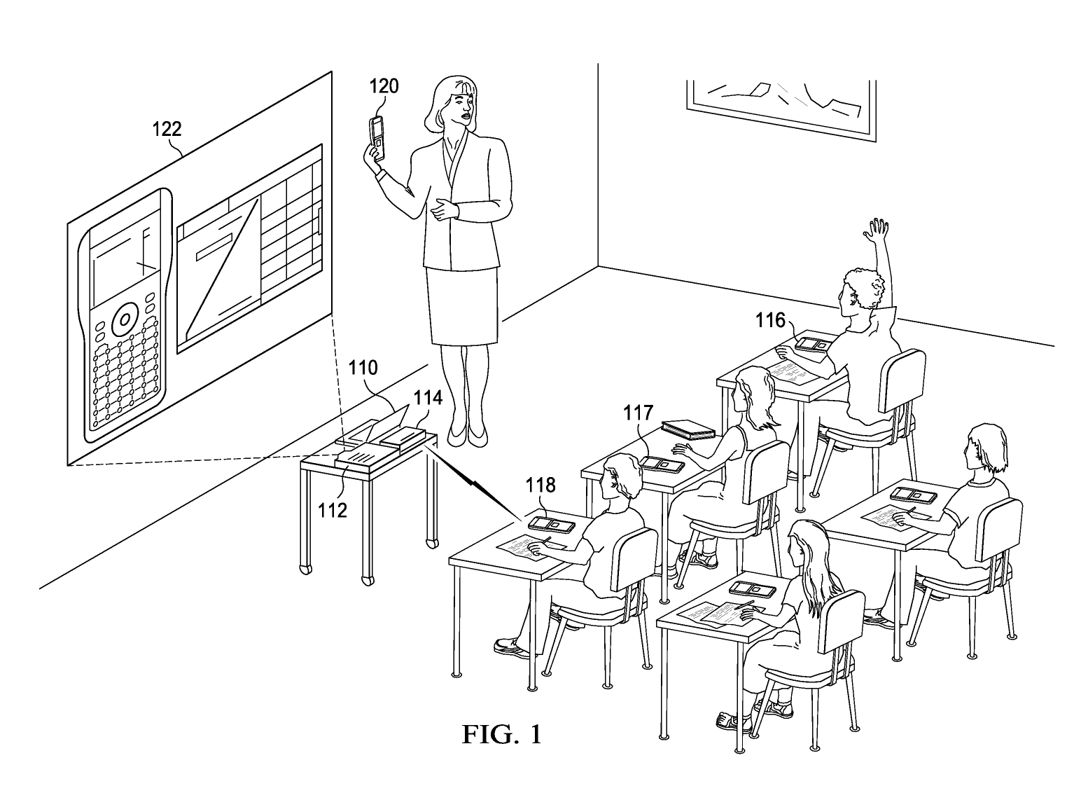

FIG. 1 shows a diagram of a classroom network configured to allow a teacher to interact with students using their student devices. A teacher may use an interactive instruction system, e.g., a handheld calculator connected to a computer system and a display device such as a digital projector and screen or interactive whiteboard, in a classroom to replicate the display of the handheld calculator in real time in a larger format on the display device for viewing by students, i.e., for presenting digital instruction to the students. More specifically, the teacher may perform operations using the handheld calculator and allow the students to view the results of the operations in real-time in the larger format provided by the display device. A teacher may also record in video from a sequence of operations performed on the handheld calculator, e.g., a lesson, in a file and play the recorded video to present it on the display device. The TI-Nspire™ software may be loaded onto a student's BYOD and enable users to perform the same functions on a computer system that can be performed on a TI-Nspire™ calculator, i.e., the software emulates the calculator operation. Documents generated using the TI-Nspire™ software can be used on a TI-Nspire™ calculator and vice versa. A student versions of the TI-Nspire™ software are described in “TI-nspire™ Student Software Guidebook”, Texas Instruments Incorporated, 2006-2013. Use of the TI-Nspire software on an iPAD® is described in “Welcome to the TI-Nspire™ App for iPad®”, 2013, which is incorporated by reference herein.

As shown in FIG. 1, the classroom network may include a computer system 110 communicatively coupled to a projector 112 (e.g., a digital projector), which may project images and video provided by the computer system 110 onto a wall, screen, or other surface. Computer system 110 may include presentation software (not shown) for managing the presentation of screen content received from a student BYOD as the device is operated. The presentation may be made using a display device in the computer system 110, or using a combination of the display device and the projector 112. The computer system 110 may be any general purpose computing device, such as a desktop computer, a mini-computer, a main frame, a laptop computer, a netbook, a tablet computer, or the like.

The computer system 110 may also be communicatively coupled to an access point 114 via a Universal Serial Bus (USB) connection, for example. The access point 114 provides a wireless interface such as 802.11b, 802.11g, or the like for the computer system 110 to communicate with one or more student devices 116-118. Once connected, bi-directional communications may be performed between the student devices and the computer system 110 via the access point 114. The computer system 110 and the access point 114 are illustrated as separate components for illustrative purposes only. In some embodiments, the access point 114 may be integrated into the computer system 110. Further, the coupling between the access point 114 and the computer system 110 may be any suitable wired or wireless connection. The combination of the computer system 110 and the access point 114 may be the network host for the classroom network.

The student devices 116-118 may be any suitable computer device, such as: handheld calculators, such as graphing calculators in the TI-Nspire product line available from Texas Instruments, Inc., for example; tablets, iPads, laptops, smart phones, etc, for example. To allow wireless communication with the access point 114 and/or the computer system 110, a wireless transceiver may be integrated into each device 116-118 or a wireless adaptor or a wireless cradle may be externally attached via a port on one or more of the devices 116-118, for example.

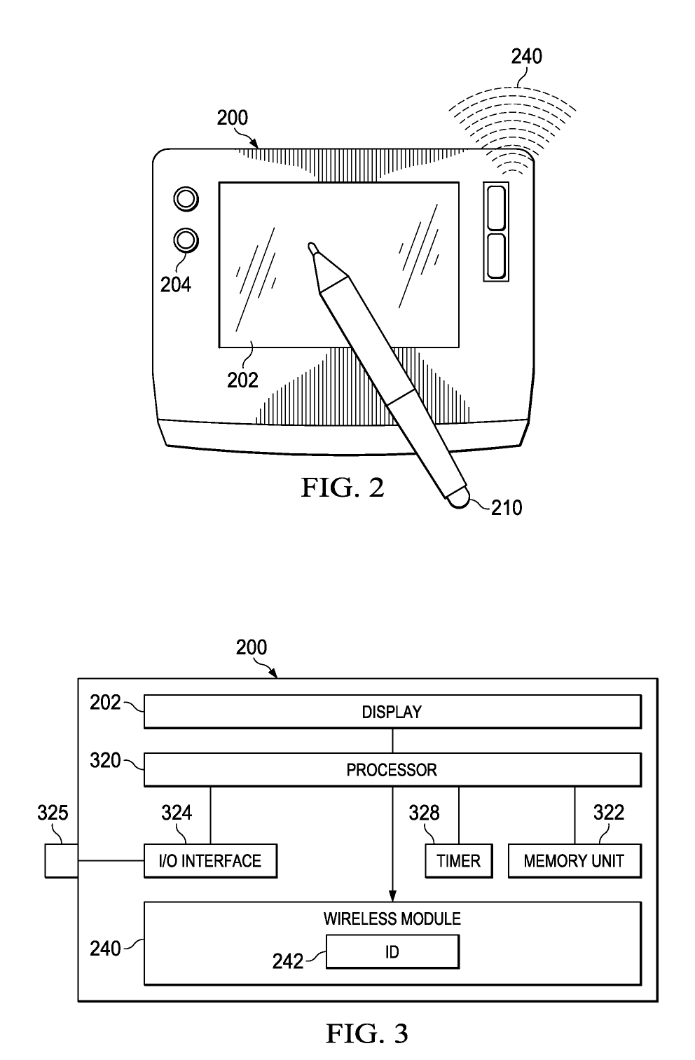

FIGS. 2 and 3 illustrate an example computer device 200 for a student in the classroom of FIG. 1 that is equipped with a network interface 240. As mentioned above, device 200 is representative of devices 116-118 and may be, for example, a calculator, a tablet computer, an iPad, a laptop computer, a smart phone, etc, for example. Devices with more or fewer components than illustrated herein may be used in embodiments of the invention.

As shown in FIG. 2, the student device may include a graphical display 202, and a keypad that may include one or more keys 204, a touchpad, etc. The graphical display 202 may be used to display, among other things, information input to applications executing on the handheld device 200 and various outputs of the applications. The graphical display 202 may be, for example, an LCD display. Display 202 may be touch sensitive and may provide a virtual keypad in place of or in addition to a physical keypad. Touch sensitive display 202 may also provide the functions of a touchpad to allow a user to input motion commands to device 200, for example. A user may interact with a touch sensitive screen 202 by using a finger or a pointing device, such as pointer 210, for example.

The virtual and/or physical keypad allows a user, e.g., a student or instructor, to enter data and functions and to start and interact with applications executing on the handheld device 200. The keypad may also include an alphabetic keyboard for entering text. A touchpad may allow a user to interact with the display by translating the motion and position of the user's fingers on the touchpad to provide functionality similar to using an external pointing device, e.g., a mouse. A user may use touch sensitive screen 202 in a similar manner to a touchpad to perform operations similar to using a pointing device on a computer system, e.g., scrolling the display 202 content, pointer positioning, selecting, highlighting, etc.

A wireless module 240 is typically included within device 200. If not, an external wireless adaptor may be communicatively coupled to device 200 by a connector, for example. Wireless module 240 may provide a wireless interface such as 802.11b, 802.11g, or the like for wireless communication with the classroom network and thereby with the computer system 110 using known or later developed techniques. A unique identification (ID) code 242 may be included within wireless module 240. ID code 242 may be the MAC (media access control) address of the wireless interface, for example. ID code 242 may be stored within a read only memory (ROM) chip, or other type of non-volatile storage device such as an electrically programmable ROM device or a flash ROM, for example to allow each student device to be uniquely identified on the network. In another embodiment, wireless module 240 with ID 242 may be configured as a cradle that provides physical support for device 200, for example.

Device 200 typically includes a processor 320 coupled to a memory unit 322, which may include one or both of read-only memory (ROM) and random-access memory (RAM). In some embodiments, the ROM stores software programs and the RAM stores intermediate data and operating results. An input/output port 325 may provide connectivity to external devices, e.g., a wireless adaptor or wireless cradle, for example. In one or more embodiments, the input/output port 325 is a bi-directional connection such as a mini-A USB port. Also included in the handheld device 200 is a display 202, as described in more detail above, and an I/O interface 324. The I/O interface 324 provides an interface to couple input devices such as a touchpad and a keypad 204 to the processor 320. In some embodiments, the handheld device 200 may also include an integrated wireless interface 240, as described in more detail above. In one or more embodiments, the memory unit 322 stores software instructions to be executed by the processor 320 to implement some or all of the device based operations of guided tool tips for expression calculation methods described herein.

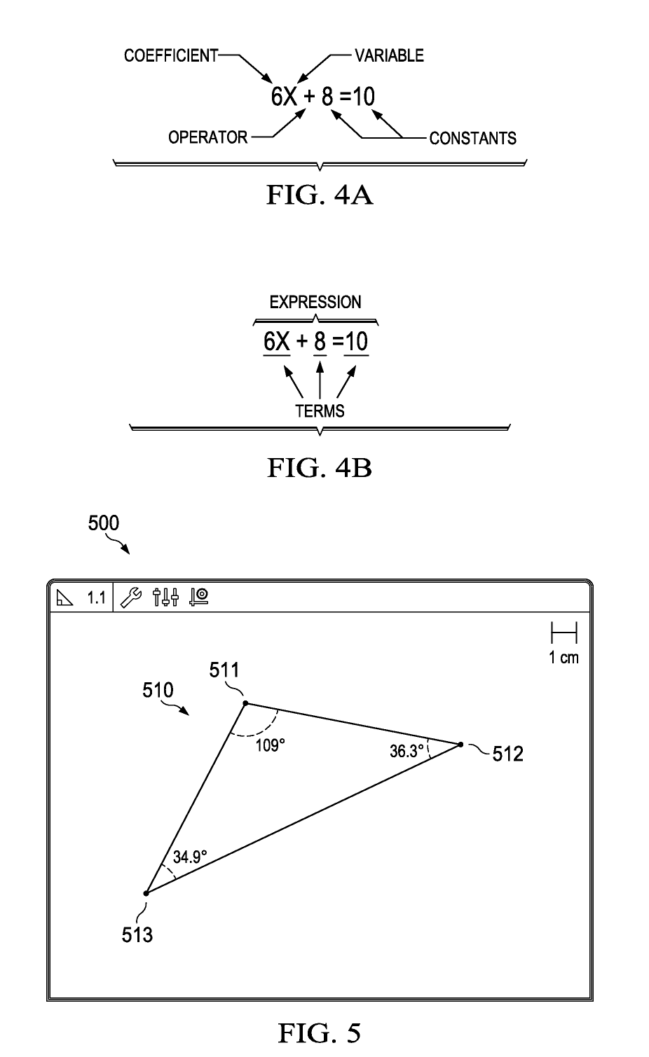

FIGS. 4A-4B illustrate the various parts of an equation and terminology that will be used in the following description. A variable is a symbol for a number that is not yet known. It is usually a letter such as x or y, for example. A number on its own is called a constant. A coefficient is a number used to multiply a variable. An operator is a symbol, such as +, −, ×, etc, that represents an operation between adjacent terms.

As illustrated in FIG. 4B, a term may be either a single number or a variable, or a group of numbers and variables multiplied together. An expression is a group of terms, in which the terms are separated by + or − operators.

FIGS. 5-12 illustrate an example of using a guide tool to evaluate an expression. As discussed above, embodiments of the guide tool will now be described with respect to an embodiment on a tablet computer that contains software applications that provide functionality that is similar to a hand held graphing calculator. It should be noted, however, that embodiments of the present invention may be useful for other types of electronic devices, e.g., laptop computers, desktop computers, handheld computing devices. Examples of other types of handheld computing devices in which embodiments of the present invention may be useful include scientific calculators, advanced calculators able to upload and run software applications, handheld-sized limited-purpose computer devices, handheld-sized educational computer devices, handheld-sized portable computer devices, portable computer devices, personal digital assistants (PDAs), palmtop computers, cellular or mobile telephones, and any combination thereof.

FIG. 5 illustrates a window 500 that may be displayed on a display screen of the tablet, for example. Window 500 may also be referred to as a page and may encompass the whole display screen, or may be one of several pages on the display screen, for example. In this example, a student wants to get the sum of the angles of a triangle, such as triangle 510. The following is the description of the different steps required using TI-Nspire™ and TI-Nspire™ CAS (computer algebra system) for iPad to obtain this result.

Triangle 510 may drawn by the student by selecting the triangle construction tool from the Shapes→Triangle menu. Visual feedback that the Triangle tool is selected is provided. After the student draws the three sides of the triangle, the measurement tool may be selected to determine the values of the three angles 511-513. In some embodiments, the values of angle 511-513 may be presented when the triangle is drawn without requiring use of the measurement tool by the student, for example.

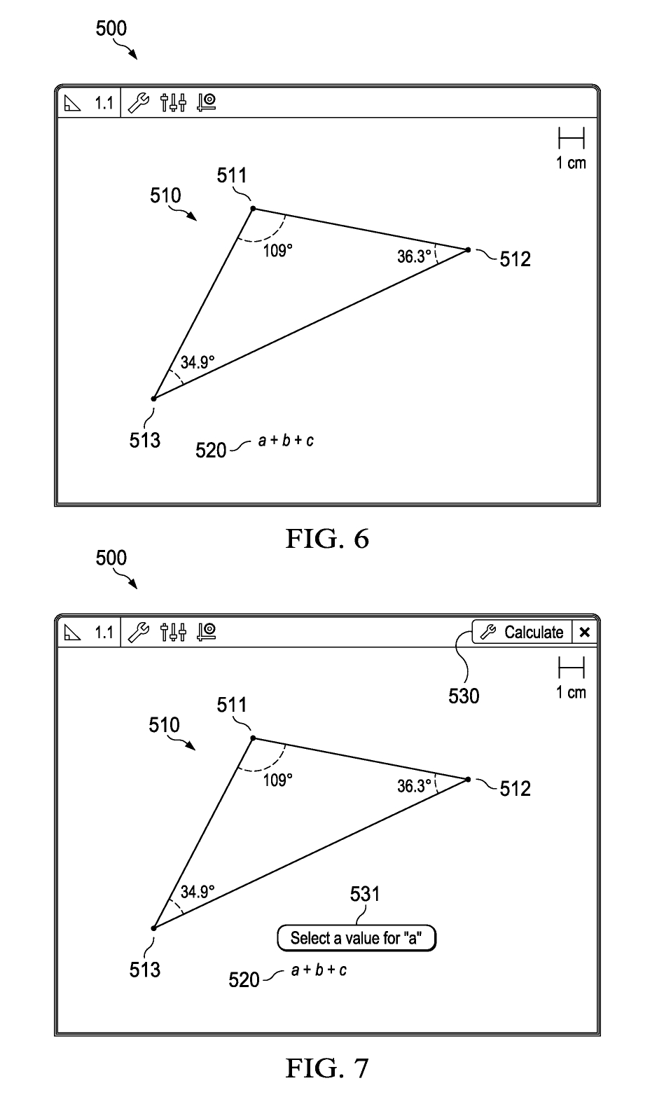

FIG. 6 illustrates an expression 520 to evaluate that the student has entered by accessing the tools (Actions→Text). As can be seen, expression 520 has three variables: a, b, and c. In this example, the student wants to know the sum of the three angles 511-513 and has therefore entered an expression with three variables. A guide tool with visual feedback may now be used to guide the user through a process to select the associated arguments to the expression 520. In this example, the student is interested in a summation of the angles 511-513, for example.

In FIG. 7, the student has selected the Calculate tool 530 from the tools menu (Actions→Calculate). Expression 520 is automatically selected, if only one expression exists in page 500, and a guided tooltip 531 is displayed to specify a data item (an argument) to select for the expression. Guided tooltip 531 instructs the student to select a value for variable “a”. In response, the student may select the value for angle 512 by pointing to it using a pointer, finger, mouse or other pointing device, for example.

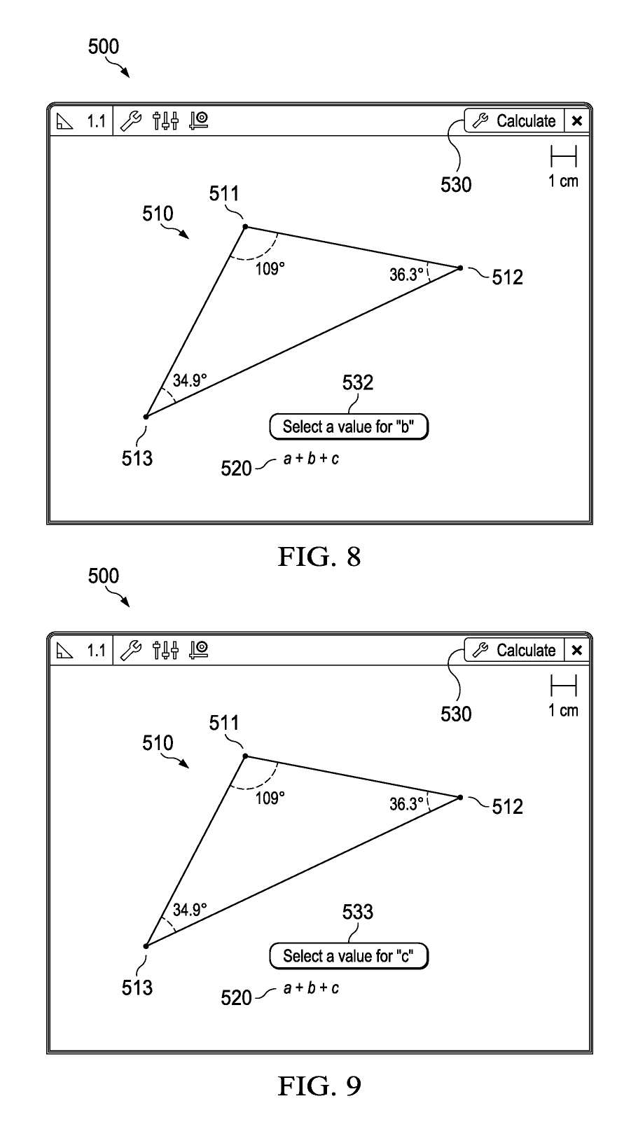

FIG. 8 illustrates that after being selected, the value for angle 512 is highlighted and a second guided tooltip 532 is presented on the display screen. Guided tooltip 532 instructs the student to select a value for variable “b”. In response, the student may select the value for angle 513 by pointing to it using a pointer, finger, mouse or other pointing device, for example.

FIG. 9 illustrates that after being selected, the value for angle 513 is highlighted and a third guided tooltip 533 is presented on the display screen. Guided tooltip 533 instructs the student to select a value for variable “c”. In response, the student may select the value for angle 511 by pointing to it using a pointer, finger, mouse or other pointing device, for example.

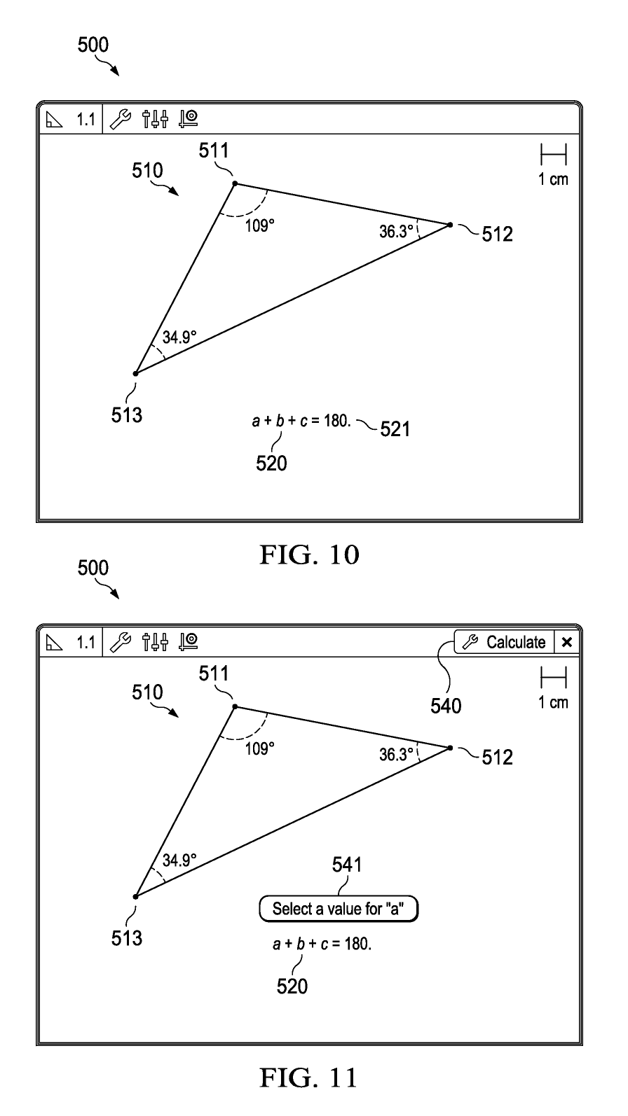

FIG. 10 illustrates once the last variable “c” for expression 520 has been selected by the student in response to the guided tooltip 533, a result 521 is calculated and displayed.

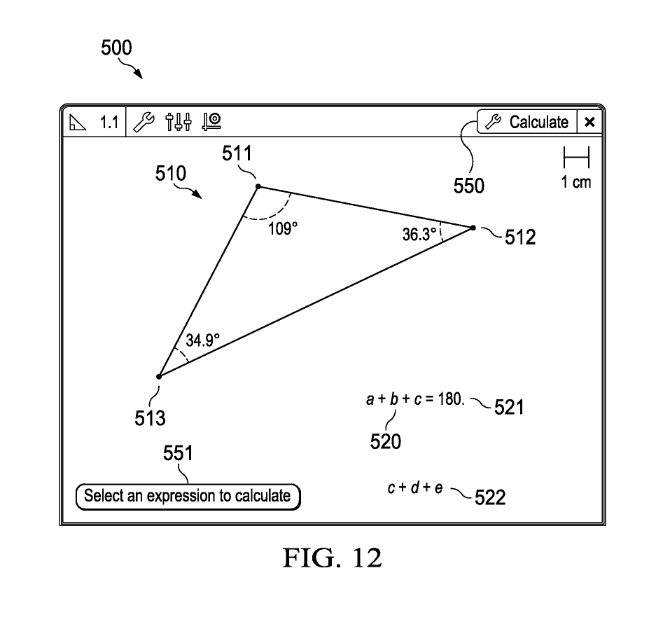

FIG. 11 illustrates a continuation in which the student wishes to recalculate the existing expression 520 and again selects 540 the Calculate tool from Tools>Actions→Calculate. The expression 520 is again automatically highlighted and a sequence of tooltips, such as 541, again guides the student to select the arguments to the expression 520. In this case, the student may have adjusted the size if triangle 510 by moving one or more vertex, for example. The selected angles from the previous pass are highlighted when the calculate tool is invoked on expression 520. As soon as the student selects the first variable in this second calculation, the selected angles form the previous pass are no longer highlighted, and the new values selected are highlighted one by one, as the user picks them.

The student may want to select the value of the lengths of each side of triangle 510 instead of selecting values of angles 511-513, for example. In this case, the measurement tool may be selected to determine the values of length of the three sides of triangle 510. In some embodiments, the values of length of the sides may be presented when the triangle is drawn without requiring use of the measurement tool by the student, for example.

FIG. 12 illustrates another example in which the student has entered a second expression 522. The student has again selected 550 the Calculate tool from the tools menu (Actions→Calculate). In this case, since there are two expressions 520, 522 within window 500, a guided tooltip 551 is displayed to guide the student to select an expression to calculate. Once the student selects an expression by pointing to it using a pointer, finger, mouse or other pointing device, for example, then the guide tool presents a sequence of guided tooltips to select values for the variables of the selected expression.

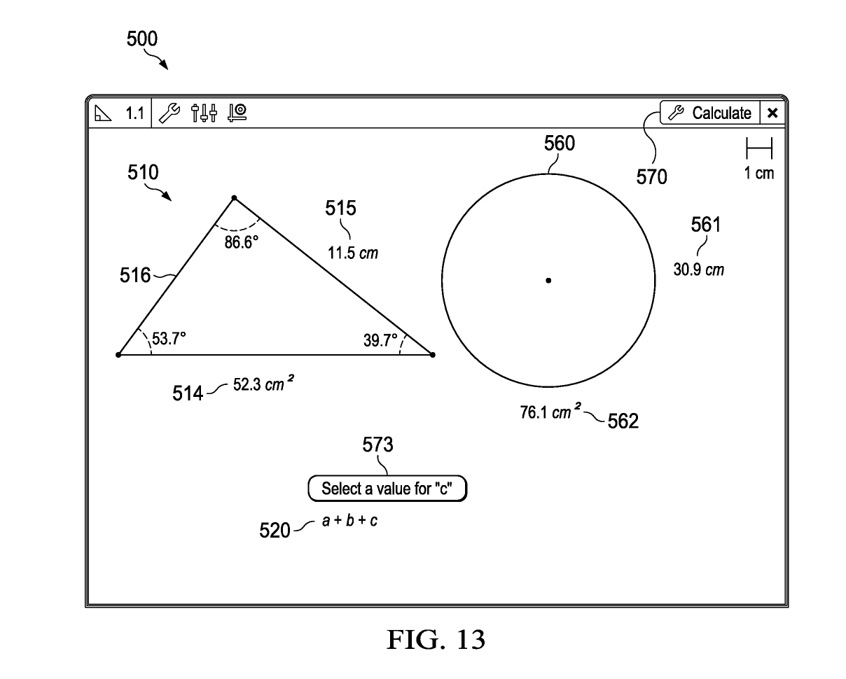

FIG. 13 illustrates a more complicated example in which the student has drawn a triangle 510 and a circle 560. The student has again selected 570 the Calculate tool from the tool menu and tooltips guiding the student to select values for variables “a” and “b” have led the student to select side length values 514 and 515, for example. Guided tooltip 573 is now guiding the student to select a value for variable “c”. Depending on what the student is trying to do, the student may select the measurement tool to determine the length of side 516 and then select that measured value for variable “c”, for example. Alternatively, the student may choose to select one of the values 561, 562 that relate to circle 560 as the value for variable “c”, for example. In this example, value 561 is the circumference of circle 560 and was determined by the student using an appropriate measurement tool, while value 562 is the area of circle 560 that was determined by the student using an appropriate measurement tool.

While the examples described herein illustrate selecting a presented or measured value for each variable of an expression, in some embodiments a student may be able to select the result of another expression. For example, referring again to FIG. 12, if the student selected expression 522 in response to guided tooltip 551, then the student may select result 512 in response to a guided tooltip to select a value for variable “c”, “d” or “e”, for example.

In another embodiment, a student may be able to select a value of another term besides the result term in one expression to be used as the value for a variable in another expression, for example.

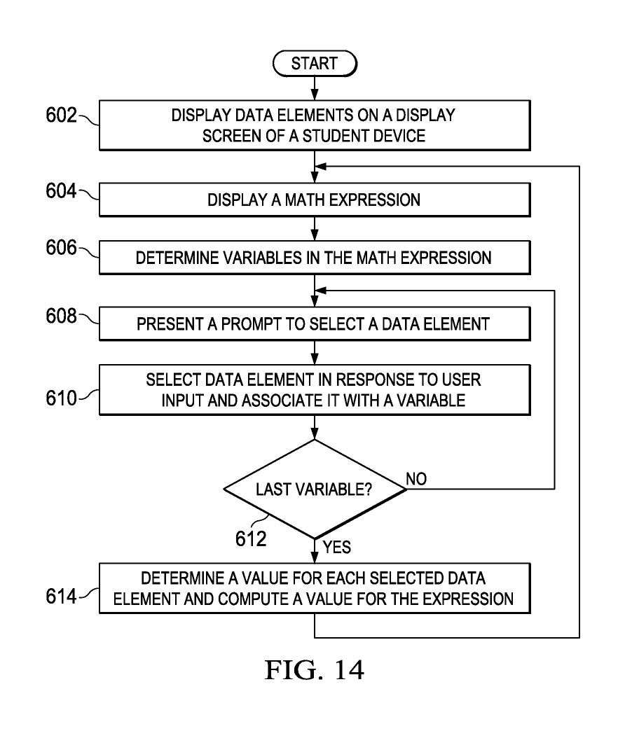

FIG. 14 is a flow diagram of a method for using a guide tool to evaluate expressions, as described above. As discussed above, a student device may be a table computer, a laptop computer, a desktop computer, a handheld computing device, etc. Examples of other types of handheld computing devices in which embodiments of the present invention may be useful include scientific calculators, advanced calculators able to upload and run software applications, handheld-sized limited-purpose computer devices, handheld-sized educational computer devices, handheld-sized portable computer devices, portable computer devices, personal digital assistants (PDAs), palmtop computers, cellular or mobile telephones, and any combination thereof.

One or more data elements are displayed 602 on a display screen of the student device. The data elements may be related to a graphical object that is displayed on the display screen, or may be terms of one or more math expressions that are displayed on the display screen, for example. For example, the graphical object may a triangle, circle, rectangle or a more complex object, for example. A data element may be the length value of a side of the graphical object or may be an value of an angle of a vertex of the object, for example. A data element may be a result term or a term other than the result term of a math expression being displayed on the display screen, for example.

A math expression is displayed 604 on the display screen of the student device. The math expression may have been entered by the student using a virtual or physical keyboard that is coupled to or part of the student device, for example. The math expression may be provided by a teaching application that is being executed on the student device, for example. The math expression may be provided by a teacher that has entered it into the teacher's device and downloaded it do students in a class room using a network, such as described in FIG. 1, for example.

The variables in the expression are determined 606 by parsing the expression. A calculation application being executed on the student device parses the expression using known mathematical rules to determine the variable in the expression.

A guided tool application may then provide a sequence of “guided tooltip” that lead the student through a process to evaluate the math expression. A first guided tooltip prompt is presented 608 by the student device to select a first one of the variables to associate with one of the data elements. The prompt may be an audible prompt played via a speaker or headset attached to the student device, or it may be a visual prompt that is provided on the display screen of the student device, for example.

In response to the guided tooltip, the student may select one of the data items that are being displayed on the display screen of the student device by pointing to it using a pointer, finger, mouse or other pointing device, for example. In response to the student input, the calculation application selects 610 the data element and associates it with the first variable.

In some embodiments, the calculation application may indicate when a particular data item has been selected for association with a variable. A selected data item may be indicated by various means, such as by highlighting, underlining, putting a box or circle around it, blinking, changing color, bolding, etc, for example.

The calculation application may continue to provide guided tooltips until 612 all of the variables of the math expression have been associated with selected data items.

Once all of the variables have been associated with data items, then the calculation application may determine 614 a value for each data element associated with each variable of the expression. If the value of the data item was already displayed on the screen of the student device, then no additional work is needed. If the value of the data item was not already known, then additional guided tooltip prompts may be provided to guide the student to use a measurement tool to determine a data item value, for example. In other cases, if a data item is a term of another expression, then the other expression may need to be evaluated, for example. Once all of the selected data items have known values, then the math expression may be evaluated 614 and the result displayed on the screen of the student device.

As discussed with regard to FIG. 12, additional math expressions may be entered and displayed 604 on the screen of the student device. Terms of one expression may be selected 610 as data items to be associated with variables in another expression.

When there are more than one expressions being displayed on the display screen, when a student selects a first one of the expressions the data items associated with the first expression may be highlighted, and then when the student selects a second one of the expressions the data items associated with the second expression are highlighted and the others are returned to normal.

In this manner, a guide tool may provide real time feedback for users when evaluating an expression. A consistent way to understand mathematical concepts associated with an expression is provided.

### Other Embodiments

While the invention has been described with respect to a limited number of embodiments, those skilled in the art, having benefit of this disclosure, will appreciate that other embodiments can be devised which do not depart from the scope of the invention as disclosed herein.

For example, embodiments are discussed described in which the digital devices may be handheld calculators. It should be noted, however, that other types of digital devices, e.g., laptop computers, desktop computers, tablet computers, and handheld computing devices may be used. Examples of other types of handheld computing devices include scientific calculators, advanced calculators able to upload and run software applications, handheld-sized limited-purpose computer devices, handheld-sized educational computer devices, handheld-sized portable computer devices, portable computer devices, personal digital assistants (PDA), palmtop computers, cellular or mobile telephones, and any combination thereof.

In one embodiment of the invention, a plurality of mathematical expressions is created in a dynamic computational environment in response to user input. In a dynamic computational environment, a change made to any one of the plurality of mathematical expressions will be propagated to all of the mathematical expressions, such that each of the plurality of mathematical expressions affected by the change is updated. Thus, the dynamic computing environment allows a variable to be changed in a graphing environment and then propagated back to an algebraic environment that defines the expressions being graphed, for example.

Embodiments of a guide tool were described herein in conjunction with a calculation tool provided by the TI-Nspire™ and TI-Nspire™ CAS application programs. In other embodiments, a guide tool as described herein may be used in conjunction with calculation tools provided by other applications, such as Geogebra, MathStudio, PocketCAS, for example.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope and spirit of the invention.

What is claimed is:

1. A method for operating a student device, the method comprising:
displaying one or more data elements on a display screen of the student device;
displaying an expression on the display screen of the student device;
determining variables in the expression by parsing the expression;
presenting a prompt by the student device to associate a first one of the variables with one of the data elements; and
selecting a data element in response to user input to the student device and associating the selected data element with the first variable.

2. The method of claim 1, further comprising repeating the steps of presenting a prompt, selecting a data element, and associating the selected data element with a variable for each one of the variables in the equation.

3. The method of claim 2, further comprising:
determining a value for each data element associated with each variable of the expression; and
computing and displaying a value for the expression in response to determining a value for each variable of the expression.

4. The method of claim 1, further comprising receiving the expression in response to user input to the student device.

5. The method of claim 1, further comprising displaying one or more of the data elements in response to user input to an interactive measurement tool provided by the student device.

6. The method of claim 1, further comprising displaying a second expression on the display screen; and wherein one of the data elements is a term of the second expression.

7. The method of claim 1, further comprising visually indicating on the display screen that the data element has been selected.

8. A student device for use in a classroom, the device comprising:
a display screen and storage memory coupled to a processor operable to execute software instructions stored in the memory;
an input mechanism for data input and for selection of items on the display screen coupled to the processor; and
wherein by executing the software instructions, the processor is operable to perform a method comprising:
displaying one or more data elements on the display screen of the student device;
displaying an expression on the display screen of the student device;
determining variables in the expression by parsing the expression;
presenting a prompt by the student device to associate a first one of the variables with one of the data elements; and
selecting a data element in response to user input with the input mechanism and associating the selected data element with the first variable.

9. The student device of claim 8, further comprising repeating the steps of presenting a prompt, selecting a data element, and associating the selected data element with a variable for each one of the variables in the equation.

10. The student device of claim 9, further comprising:
determining a value for each data element associated with each variable of the expression; and
computing and displaying a value for the expression in response to determining a value for each variable of the expression.

11. The student device of claim 8, further comprising receiving the expression in response to user input to the input mechanism.

12. The student device of claim 8, further comprising displaying one or more of the data elements in response to user input to the input mechanism to an interactive measurement tool provided by an application executed by the processor of the student device.

13. The student device of claim 8, further comprising displaying a second expression on the display screen; and wherein one of the data elements is a term of the second expression.

14. The student device of claim 8, further comprising visually indicating on the display screen that the data element has been selected.

15. A non-transitory computer-readable medium storing software instructions that, when executed by a processor, perform a method for operating a student device, the method comprising:
displaying one or more data elements on a display screen of the student device;
displaying an expression on the display screen of the student device;
determining variables in the expression by parsing the expression;
presenting a prompt by the student device to associate a first one of the variables with one of the data elements; and
selecting a data element in response to user input to the student device and associating the selected data element with the first variable.

16. The method of claim 15, further comprising repeating the steps of presenting a prompt, selecting a data element, and associating the selected data element with a variable for each one of the variables in the equation.

17. The method of claim 16, further comprising:
determining a value for each data element associated with each variable of the expression; and
computing and displaying a value for the expression in response to determining a value for each variable of the expression.

18. The method of claim 15, further comprising receiving the expression in response to user input to the student device.

19. The method of claim 15, further comprising displaying a second expression on the display screen; and wherein one of the data elements is a term of the second expression.

20. The method of claim 15, further comprising visually indicating on the display screen that the data element has been selected.
